(19) United States
(12) Patent Application Publication
(10) Pub. No.: US 2022/0230501 A1
(43) Pub. Date: Jul. 21, 2022

(54) COIN LOADING METHOD, COIN REPLENISHMENT METHOD, COIN LOADING APPARATUS AND COIN PROCESSING SYSTEM

(71) Applicant: Glory Ltd., Hyogo (JP)

(72) Inventors: Kenichi TAGASHIRA, Hyogo (JP); Osamu ITO, Hyogo (JP); Rikuo MINAGAWA, Hyogo (JP); Kiyoaki KOBAYASHI, Hyogo (JP); Risa HORITA, Hyogo (JP); Rinshiro IWASE, Saitama (JP)

(73) Assignee: Glory Ltd., Hyogo (JP)

(21) Appl. No.: 17/567,887

(22) Filed: Jan. 4, 2022

(30) Foreign Application Priority Data
Jan. 15, 2021 (JP) 2021-005157

(51) Int. Cl. G07D 9/00

(52) U.S. Cl. CPC G07D 9/002

(57) ABSTRACT

A coin loading method is a method of loading coins for replenishment of a coin processing apparatus, into a storage area provided in a cassette that is mountable to the coin processing apparatus, the coin loading method being performed before the cassette is mounted to the coin processing apparatus, the coin loading method including: loading, into the storage area, a first coin group including a first plurality of coins for initial replenishment of the coin processing apparatus; and loading, into the storage area, a second coin group including a second plurality of coins for additional replenishment of the coin processing apparatus. At least one of the first plurality of coins and the second plurality of coins includes the plural coins of each denomination of a plurality of denominations.

### CROSS-REFERENCE TO RELATED APPLICATION

This application claims priority to Japanese Application No. 2021-005157, filed Jan. 15, 2021, the entire contents of which are incorporated herein by reference.

### TECHNICAL FIELD

The present disclosure relates to a coin loading method, a coin replenishment method, a coin loading apparatus and a coin processing system.

### BACKGROUND ART

In the related art, coin depositing and dispensing machines that perform a coin depositing and dispensing process are known (see, for example, PTL 1). The coin depositing and dispensing machine disclosed in PTL 1 includes a replenishment collection cassette. A partition plate and an opening closing plate that opens and closes an opening of the partition plate are provided at an intermediate part in the replenishment collection cassette. A coin replenishment transport belt and an outlet are provided at a lower portion in the replenishment collection cassette. The replenishment collection cassette stores coins for initial replenishment on the lower side than the partition plate, and stores coins for additional replenishment on the upper side of the partition plate.

The coin depositing and dispensing machine further includes a coin replenishment cassette including a plurality of denomination basis replenishment coin storage units. A shutter is provided at the lower end of each of the plurality of denomination basis replenishment coin storage units.

When replenishing the dispense coin storage unit with a coin for initial replenishment stored in the replenishment collection cassette, the coin depositing and dispensing machine replenishes the dispense coin storage unit by driving the coin replenishment transport belt to output, from the outlet, a coin for initial replenishment stored on the lower side than the partition plate of the replenishment collection cassette. When the replenishment of the coin for initial replenishment is completed, the coin depositing and dispensing machine drives the coin replenishment transport belt, opens the opening closing plate of the replenishment collection cassette, outputs, from the outlet, the coin for additional replenishment stored on the upper side than the partition plate of the replenishment collection cassette, and stores it in a collection box.

When performing additional replenishment in the dispense coin storage unit, the coin depositing and dispensing machine opens the shutter of the denomination basis replenishment coin storage unit in which to store the coin to be added, and replenishes the dispense coin storage unit with the coin in the denomination basis replenishment coin storage unit. When there is no coin in the denomination basis replenishment coin storage unit, the coin depositing and dispensing machine replenishes the dispense coin storage unit with coins stored in the collection box.

### CITATION LIST

### Patent Literature

PTL 1
Japanese Patent Publication No. 2935452

### SUMMARY

A coin loading method according to the present disclosure is a method of loading coins for replenishment of a coin processing apparatus, into a storage area provided in a cassette that is mountable to the coin processing apparatus, the coin loading method being performed before the cassette is mounted to the coin processing apparatus, the coin loading method including: loading, into the storage area, a first coin group including a first plurality of coins for initial replenishment of the coin processing apparatus; and loading, into the storage area, a second coin group including a second plurality of coins for additional replenishment of the coin processing apparatus. At least one of the first plurality of coins and the second plurality of coins includes the plural coins of each denomination of a plurality of denominations.

A coin replenishment method according to the present disclosure is a method of replenishing a coin processing apparatus with coins, the coin replenishment method including: mounting a cassette to the coin processing apparatus, the cassette being loaded with coins of a plurality of denominations by the coin loading method; receiving a coin from the cassette; recognizing a denomination of a received coin; determining whether it is necessary to replenish the coin processing apparatus with a recognized coin; replenishing the coin processing apparatus with the recognized coin when it is determined that it is necessary to perform replenishment; and returning the recognized coin to the cassette when it is determined that it is not necessary to perform replenishment.

A coin loading apparatus according to the present disclosure is configured to load coins for replenishment of a coin processing apparatus, into a storage area provided in a cassette that is mountable to the coin processing apparatus, the coin loading apparatus including: a storage unit configured to store coins by denomination; a loading unit configured to load coins stored in the storage unit into the storage area; and a control unit configured to control the storage unit and the loading unit to load a first coin group including a first plurality of coins for initial replenishment of the coin processing apparatus and a second coin group including a second plurality of coins for additional replenishment of the coin processing apparatus, into the storage area at different timings before the cassette is mounted to the coin processing apparatus. At least one of the first plurality of coins and the second plurality of coins includes the plural coins of each denomination of a plurality of denominations.

A coin processing system according to the present disclosure includes: a coin processing apparatus; a cassette that is mountable to the coin processing apparatus, the cassette including a storage area; and a coin loading apparatus configured to load a coin for replenishment in the coin processing apparatus into the storage area. The coin loading apparatus includes: a storage unit configured to store coins by denomination; a loading unit configured to load coins stored in the storage unit into the storage area; and a control unit configured to control the storage unit and the loading unit to load a first coin group including a first plurality of coins for initial replenishment of the coin processing apparatus and a second coin group including a second plurality of coins for additional replenishment of the coin processing apparatus, into the storage area at different timings before the cassette is mounted to the coin processing apparatus. At least one of the first plurality of coins and the second plurality of coins includes the plural coins of each denomination of a plurality of denominations.

### BRIEF DESCRIPTION OF DRAWINGS

FIG. 1 is a block diagram illustrating an overall configuration of a coin processing system according to Embodiment 1 and Embodiment 2 of the present disclosure;

FIG. 2 is a longitudinal sectional view illustrating a loading state of a first coin group and a second coin group in a cassette according to Embodiment 1 of the present disclosure;

FIG. 3 is a flowchart of a coin loading process according to Embodiment 2 of the present disclosure;

FIG. 4 is a longitudinal sectional view illustrating a loading state of a first coin group in a cassette according to Embodiment 2 of the present disclosure;

FIG. 5 is a block diagram illustrating an overall configuration of a coin processing system according to Embodiment 3 of the present disclosure;

FIG. 6 is a flowchart of a setting process of a first denomination basis loading number according to Embodiment 3 of the present disclosure;

FIG. 7 is a block diagram illustrating an overall configuration of a coin processing system according to Embodiment 4 of the present disclosure;

FIG. 8 is a flowchart of a setting process of a first denomination basis loading number according to Embodiment 4 of the present disclosure;

FIG. 9 is a flowchart of a setting process of a second denomination basis loading number according to Embodiment 4 of the present disclosure;

FIG. 10 is a block diagram illustrating an overall configuration of a coin processing system according to Embodiment 5 of the present disclosure;

FIG. 11A is a top view illustrating an overall configuration of a cassette according to Embodiment 5 of the present disclosure;

FIG. 11B is a sectional view taken along XIB-XIB of FIG. 11A;

FIG. 12 is a schematic view as viewed from the right side, illustrating an internal configuration of a coin processing apparatus according to Embodiment 5 of the present disclosure;

FIG. 13A is a schematic view as viewed from the right side, illustrating an internal configuration of a coin loading apparatus when a coin is loaded into a cassette according to Embodiment 5 of the present disclosure;

FIG. 13B is a schematic view as viewed from the front side, illustrating an internal configuration of the coin loading apparatus when a coin is loaded into the cassette according to Embodiment 5 of the present disclosure; and

FIG. 14 is a flowchart of a coin loading process according to Embodiment 5 of the present disclosure.

### DESCRIPTION OF EMBODIMENTS

The replenishment collection cassette disclosed in PTL 1 includes the opening closing plate that closes to store the coin for additional replenishment and opens to eject the coin, and as such the configuration cannot be simplified. In addition, the coin replenishment cassette disclosed in PTL 1 includes the plurality of denomination basis replenishment coin storage units that stores coins by denomination, and as such the configuration cannot be simplified.

An object of the present disclosure is to provide a coin loading method, a coin replenishment method, a coin loading apparatus and a coin processing system that can appropriately load the cassette with the coin for initial replenishment in the coin processing apparatus and the coin for additional replenishment in the coin processing apparatus while simplifying the configuration of the cassette.

In the coin loading method of the present disclosure, the loading of the first coin group may be executed at an earlier timing than the loading of the second coin group, or the loading of the second coin group is executed at an earlier timing than the loading of the first coin group.

In the coin loading method of the present disclosure, the cassette may include an inlet configured to receive a coin from outside of the cassette and store the coin in the storage area, and an outlet provided at a position lower than the inlet in a state where the cassette is mounted to the coin processing apparatus, the outlet being configured to eject the coin loaded into the storage area to the coin processing apparatus. The loading of the first coin group may be executed at an earlier timing than the loading of the second coin group.

In the coin loading method of the present disclosure, the cassette may include an outlet configured to eject the coin loaded into the storage area to the coin processing apparatus. In the loading of the second coin group, the second coin group may be loaded into a location farther from the outlet than the first coin group.

In the coin loading method according to the present disclosure, in the loading of the second coin group, the coins included in the second coin group may be loaded into a location farther from the outlet than the coins included in the first coin group.

In the coin loading method of the present disclosure, the loading of the first coin group may include loading the first coin group into the storage area such that, among coins included in the first coin group, the fewer a number of coins of a denomination, the closer the coins are to the outlet.

The coin loading method of the present disclosure may further include setting a number of coins making up the first coin group for each denomination in accordance with a number of coins of each denomination that are present in the coin processing apparatus before initial replenishment.

The coin loading method of the present disclosure may further include: receiving an inputting operation of specifying a number of coins for each denomination by a user; and setting a number of coins of each denomination making up at least one of the first coin group and the second coin group in accordance with the inputting operation.

The coin loading method of the present disclosure may further include at least one of calculating a first ratio for each denomination, and notifying that there is a denomination whose first ratio is smaller than a first threshold value when there is the denomination whose first ratio is smaller than the first threshold value, the first ratio being a ratio of a number of coins making up the first coin group with respect to a total number of coins making up the first coin group set based on the inputting operation; or calculating a second ratio for each denomination, and notifying that there is a denomination whose second ratio is smaller than a second threshold value when there is the denomination whose second ratio is smaller than the second threshold value, the second ratio being a ratio of a number of coins making up the second coin group with respect to a total number of coins making up the second coin group set based on the inputting operation.

The coin loading method of the present disclosure may further include at least one of again receiving the inputting operation related to a number of coins of each denomination making up the first coin group when there is the denomination whose first ratio is smaller than the first threshold value; or again receiving the inputting operation related to a number of coins of each denomination making up the second coin group when there is the denomination whose second ratio is smaller than the second threshold value.

The coin loading method of the present disclosure may further include at least one of calculating a first ratio for each denomination, and setting a number of coins of each denomination making up the first coin group such that there is no denomination whose first ratio is smaller than a first threshold value when there is the denomination whose first ratio is smaller than the first threshold value, the first ratio being a ratio of a number of coins making up the first coin group with respect to a total number of coins making up the first coin group set based on the inputting operation; or calculating a second ratio for each denomination, and setting a number of coins of each denomination making up the second coin group such that there is no denomination whose second ratio is smaller than a second threshold value when there is the denomination whose second ratio is smaller than the second threshold value, the second ratio being a ratio of a number of coins making up the second coin group with respect to a total number of coins making up the second coin group set based on the inputting operation.

The coin loading method according to the present disclosure according may further include estimating a total number of excess coins that are coins left over at the coin processing apparatus without being used for the initial replenishment after the initial replenishment among the coins making up the first coin group; calculating, for each denomination, a second ratio that is the ratio of the total number of excess coins and the number of coins making up the second coin group with respect to the total number of the estimated total number of the excess coins and the total number of coins making up the second coin group set based on the inputting operation, and setting the number of coins making up the second coin group for each denomination such that there is no denomination whose second ratio is smaller than the second threshold value when there is the denomination whose second ratio is smaller than the second threshold value.

The coin replenishment method according to the present disclosure may further include: stopping the receiving of the coin from the cassette when a required coin replenishment is completed.

The coin loading method, the coin replenishment method, the coin loading apparatus and the coin processing system of embodiments of the present disclosure can appropriately load the cassette with the coin for initial replenishment in the coin processing apparatus and the coin for additional replenishment in the coin processing apparatus while simplifying the configuration of the cassette.

### EMBODIMENT

An embodiment of the present disclosure is described below. In the present disclosure, a configuration of performing a coin loading method of loading coins of a plurality of denominations into one storage area provided in a cassette that can be mounted to a coin processing apparatus is described. Note that in an embodiment of the present disclosure, the cassette includes only one storage area.

The coin loading method of the present disclosure includes a step of loading the first coin group for initial replenishment in the coin processing apparatus into the storage area, and a step of loading the second coin group for additional replenishment in the coin processing apparatus into the storage area before the cassette is mounted to the coin processing apparatus. The first coin group is composed of coins of a plurality of denominations whose number is set for each denomination. The second coin group is composed of coins of a plurality of denominations whose number is set for each denomination. In the following description, the number of the coins of each denomination making up the first coin group may be referred to as a first denomination basis loading number. The number of the coins of each denomination making up the second coin group may be referred to as a second denomination basis loading number.

The first coin group and the second coin group may be composed of coins of a plurality of denominations that are introduced only one country or region, or may be a mixture of coins of at least one denomination introduced in a first country or region and coins of at least one denomination introduced in a second country or region.

The initial replenishment is coin replenishment to set the number of coins for each denomination in the coin processing apparatus after the initial replenishment to the standard number set for each denomination. In this manner, the required number of coins for initial replenishment is determined at the time of loading the first coin group into the storage area. The first denomination basis loading number may be set based on the number of coins of each denomination remaining in the coin processing apparatus before the initial replenishment is performed (hereinafter may be referred to as “remaining coin”), by a coin loading apparatus for loading the first coin group into the storage area, an apparatus connected to the coin loading apparatus, or the user such as a clerk. In addition, in the case where the number of the remaining coins of each denomination is fixed at the same number each time, the first denomination basis loading number may be set as a fixed value. The standard number may be set for each initial replenishment, or may be a fixed value. In addition, the first denomination basis loading number may be set such that the coin making up the first coin group will not be left in the cassette after the initial replenishment or that the coin making up the first coin group will be left in the cassette after the initial replenishment. Note that in the case of an operation of collecting all coins without leaving coins in the coin processing apparatus in the closing balance operation of the coin processing apparatus, i.e., in an operation with no remaining coin, it suffices to simply set the number for the initial replenishment for each denomination as the standard number.

The additional replenishment is an operation of performing coin replenishment as necessary after the initial replenishment. The required number of coins for additional replenishment does not have to be determined at the time point of loading the second coin group into the storage area. The second denomination basis loading number may be set by the user for each loading process of the second coin group, or may be set as a fixed value.

Examples of processes performed by the coin processing apparatus where the initial replenishment and the additional replenishment of coins are performed include a process of depositing the purchase price to be paid by the customer, and a process of dispensing the change to be paid to the customer, but these processes are not limitative.

Embodiments are described in detail below. Note that in Embodiments 1 to 5, Euro coins introduced in the European Union are used as examples of coins to be loaded into the cassette, but coins introduced in other countries or regions, such as Japan and the United States, may also be used. In addition, in the following embodiments, the above-described setting number and setting method may be used as the setting number and the setting method for the first denomination basis loading number and the second denomination basis loading number, unless otherwise noted. In addition, in the following embodiments, the coin processing apparatus performs a process of depositing the purchase price to be paid by the customer and a process of dispensing the change to be paid to the customer in the store. In addition, the following embodiments, the coin for initial replenishment and the coin for additional replenishment are paid to the customer as change.

### Embodiment 1

First, Embodiment 1 of the present disclosure is described with reference to the drawings.

### Configuration of Coin Processing System

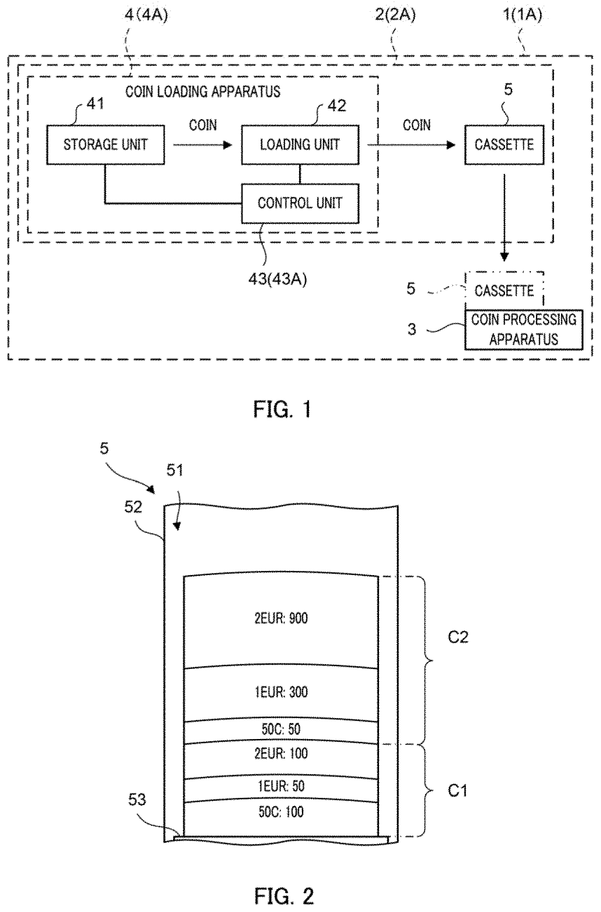

First, a configuration of a coin processing system including a coin loading apparatus is described. FIG. 1 is a block diagram illustrating an overall configuration of a coin processing system according to Embodiment 1 and Embodiment 2 of the present disclosure. FIG. 2 is a longitudinal sectional view illustrating a loading state of a first coin group and a second coin group in a cassette according to Embodiment 1 of the present disclosure.

A coin processing system 1 of Embodiment 1 illustrated in FIG. 1 includes a coin loading system 2, and a coin processing apparatus 3. The coin loading system 2 includes a coin loading apparatus 4, and a cassette 5.

The coin loading apparatus 4 loads coins of a plurality of denominations for replenishment in the coin processing apparatus 3 into one storage area 51 (see FIG. 2) provided in the cassette 5. The coin loading apparatus 4 includes a storage unit 41, a loading unit 42, and a control unit 43.

The storage unit 41 includes a plurality of denomination basis storage units not illustrated in the drawing that stores coins of a plurality of denominations by denomination. The denomination basis storage unit includes a mechanism that ejects the stored coin to the loading unit 42.

The loading unit 42 loads the coins stored in the storage unit 41 into the storage area 51. The loading unit 42 includes a mechanism that transports, into the storage area 51, the coin ejected from the storage unit 41.

The control unit 43 controls the storage unit 41 and the loading unit 42 to load a first coin group C1 for initial replenishment in the coin processing apparatus 3 (see, for example, FIG. 2) into the storage area 51.

The control unit 43 controls the storage unit 41 and the loading unit 42 to load a second coin group for additional replenishment in the coin processing apparatus 3 (see, for example, FIG. 2) into the storage area 51.

The control unit 43 performs the control of loading the first coin group C1 into the storage area 51 and the control of loading the second coin group C2 into the storage area 51 at different timings. The control unit 43 performs the control of loading the coin into the storage area 51 such that the first coin group C1 is easily output from the cassette 5 at an earlier timing than the second coin group C2. For example, the control unit 43 controls the storage unit 41 and the loading unit 42 such that the second coin group C2 is loaded at a position farther from the outlet, described later, of the cassette 5 than the first coin group C1, and thus the first coin group C1 is easily output from the cassette 5 at an earlier timing than the second coin group C2. Note that the loading of the coin included in the second coin group C2 at a position farther from the outlet of the cassette 5 than the coin included in the first coin group C1 means loading of the first coin group C1 and the second coin group C2 such that at least one coin included in the second coin group C2 is located at a position farther from the outlet than all coins included in the first coin group C1, that is, all coins included in the first coin group C1 are ejected from the outlet before all coins included in the second coin group C2 are ejected from the outlet. That is, the coin included in the first coin group C1 and the coin included in the second coin group C2 may be mixed as long as the above-mentioned loading condition is satisfied.

As illustrated in FIG. 2, the cassette 5 includes a housing 52. The inner space of the housing 52 functions as one storage area 51. The housing 52 includes a placing part 53 where coins are placed, an inlet not illustrated in the drawing for storing coins in the storage area 51, and an outlet not illustrated in the drawing for ejecting coins in the storage area 51. The cassette 5 may be configured such that the coins are ejected from the outlet in the order from the coin loaded on the lower side in the storage area 51 or that the coins are ejected from the outlet in the order from the coin loaded on the upper side in the storage area 51. An example of the cassette 5 in which the coin is ejected in the order from the coin loaded on the lower side may be a configuration that includes an outlet provided at the bottom surface or a lower side in the side surface of the housing 52 and is mounted to the coin processing apparatus 3 without changing the vertical orientation, but such a configuration is not limitative. An example of the cassette 5 in which the coin is ejected in the order from the coin loaded on the upper side may be a configuration that includes an outlet provided at the top surface or an upper side in the side surface of the housing 52 and is mounted to the coin processing apparatus 3 upside down, but such a configuration is not limitative.

### Coin Loading Process Using Coin Loading Apparatus

Next, a coin loading process using the coin loading apparatus 4 is described. Note that in Embodiment 1, the first coin group C1 is composed of 1 euro (EUR) coin, 2 euro coin and 50 cent (C) coin, and the second coin group C2 is composed of 1 euro coin, 2 euro coin, and 50 cent coin as with the first coin group C1, but the denomination and the number of the denominations of the first and second coin groups C1 and C2 are not limited to the above-mentioned configuration. In addition, a configuration is described below in which the first denomination basis loading number of the 50 cent coin is 100, the first denomination basis loading number of the 1 euro coin is 50, and the first denomination basis loading number of the 2 euro coin is 100 in the first coin group C1, whereas the second denomination basis loading number of the 50 cent coin is 50, the second denomination basis loading number of the 1 euro coin is 300, and the second denomination basis loading number of the 2 euro coin is 900 in the second coin group C2, but the first and second denomination basis loading numbers are not limited to the above-mentioned configuration.

The user mounts the cassette 5 to the coin loading apparatus 4. The control unit 43 of the coin loading apparatus 4 recognizes the first and second denomination basis loading numbers when the cassette 5 is mounted to the coin loading apparatus 4. Examples of the method of the control unit 43 to recognize the first and second denomination basis loading numbers are as follows. For example, loading number data that maps the information related to the first and second denomination basis loading numbers and the ID of the cassette 5 or the coin processing apparatus 3 is stored in a management server not illustrated in the drawing. The ID of the cassette 5 or the coin processing apparatus 3 to which the cassette 5 is mounted is recorded in a memory unit, not illustrated in the drawing, of the cassette 5. The control unit 43 may acquire the loading number data corresponding to the ID of the cassette 5 in the memory unit from the management server, so as to recognize the first and second denomination basis loading numbers based on the acquired loading number data. In addition, the loading number data may be recorded in a memory unit, not illustrated in the drawing, of the coin loading apparatus 4 or the coin processing apparatus 3, the control unit 43 may acquire the loading number data corresponding to the ID recorded in the memory unit of the cassette 5 from the memory unit of the coin loading apparatus 4 or the coin processing apparatus 3.

In the case where the cassette 5 is configured such that the coin is ejected in the order from the coin loaded on the lower side, the control unit 43 controls the storage unit 41 and the loading unit 42 such that the second coin group C2 is loaded after the first coin group C1 is loaded. As illustrated in FIG. 2, the storage unit 41 and the loading unit 42 load 100 50 cent coins, 50 1 euro coins and 100 2 euro coins, which make up the first coin group C1, into the storage area 51 in this order. Next, the storage unit 41 and the loading unit 42 load 50 50 cent coins, 300 1 euro coins and 900 2 euro coins in this order on the upper side of the first coin group C1.

On the other hand, in the case where the cassette 5 is configured such that the coin is ejected in the order from the coin loaded on the upper side, the control unit 43 controls the storage unit 41 and the loading unit 42 such that the first coin group C1 is loaded after the second coin group C2 is loaded. In this case, the storage unit 41 and the loading unit 42 load 100 2 euro coins, 50 1 euro coins and 100 50 cent coins, which make up the first coin group C1, in this order after 900 2 euro coins, 300 1 euro coins and 50 50 cent coins, which make up the second coin group C2, are loaded in this order. That is, the coins are loaded in the reverse order of the order of the cassette 5 with the configuration in which the coin is ejected in the order from the coin loaded on the lower side.

### Coin Replenishment Process Using Coin Processing Apparatus

Next, a coin replenishment process using the coin processing apparatus 3 is described.

The user removes the cassette 5 loaded with the first coin group C1 and the second coin group C2 from the coin loading apparatus 4, and mounts it to the coin processing apparatus 3 as indicated by the chain double-dashed line in FIG. 1. When the cassette 5 is mounted to the coin processing apparatus 3, the coin processing apparatus 3 ejects the coin from the outlet of the cassette 5 and performs initial replenishment in the coin processing apparatus 3. At this time, the first coin group C1 is easily output from the cassette 5 at an earlier timing than the second coin group C2, and thus the increase in replenishment time of the first coin group C1 for initial replenishment can be suppressed. Through the initial replenishment, the standard number of coins set for each denomination are stored in the coin processing apparatus 3.

In addition, when it is determined that additional replenishment of the coin is required such as when the remaining change is low, the coin processing apparatus 3 performs additional replenishment in the coin processing apparatus 3 by ejecting the coin from the outlet of the cassette 5, for example. At this time, additional replenishment of the coin making up the second coin group C2 is performed.

### Effects of Embodiment 1

The coin loading apparatus 4 loads the first coin group C1 for initial replenishment in the coin processing apparatus 3 into the storage area 51, and loads the second coin group C2 for additional replenishment in the coin processing apparatus 3 into the storage area 51, which is the same loading area as that of the first coin group C1. In this manner, since the loading of the first coin group C1 and the loading of the second coin group C2 into one storage area 51 are separately performed, the first coin group C1 and the second coin group C2 can be loaded into one storage area 51 such that the replenishment in the coin processing apparatus 3 in a predetermined order can be achieved without providing the cassette 5 with an opening closing plate that is closed for loading the second coin group C2 and opened for ejecting the second coin group C2 or with a plurality of denomination basis replenishment coin storage units. Thus, the coin loading apparatus 4 can appropriately load the cassette 5 with the coin for initial replenishment in the coin processing apparatus 3 and the coin for additional replenishment in the coin processing apparatus 3 while simplifying the configuration of the cassette 5.

### Embodiment 2

Next, Embodiment 2 of the present disclosure is described with reference to the drawings. Note that since the coin replenishment process using the coin processing apparatus is identical to that of Embodiment 1, the description of the coin replenishment process is omitted. In addition, in Embodiment 2 and Embodiments 3 to 5 described later, a cassette in which the coin loaded on the lower side is easily ejected first is exemplified.

### Configuration of Coin Loading Apparatus

A coin loading apparatus 4A and the cassette 5 of Embodiment 2 illustrated in FIG. 1 make up the coin loading system 2A. The coin loading system 2A and the coin processing apparatus 3 make up a coin processing system 1A. The coin loading apparatus 4A includes the storage unit 41, the loading unit 42, and a control unit 43A. The control unit 43A controls the storage unit 41 and the loading unit 42 such that the first coin group C1 is loaded into the storage area 51 in a state different from that of Embodiment 1. Under the control of the control unit 43A, the storage unit 41 and the loading unit 42 load the first coin group C1 into the storage area 51 such that the fewer the number of the coins of the denomination among the coins of a plurality of denominations making up the first coin group C1, the earlier the timing they are output from the cassette 5.

### Coin Loading Process Using Coin Loading Apparatus

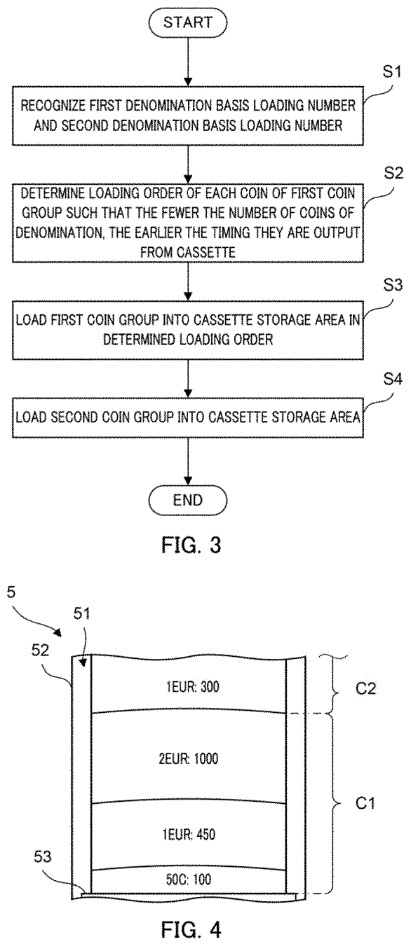

Next, a coin loading process using the coin loading apparatus 4A is described. FIG. 3 is a flowchart of a coin loading process according to Embodiment 2 of the present disclosure. FIG. 4 is a longitudinal sectional view illustrating a loading state of a first coin group in a cassette according to Embodiment 2 of the present disclosure.

As illustrated in FIG. 3, the control unit 43A recognizes the first denomination basis loading number and the second denomination basis loading number (step S1). The same method as that described in Embodiment 1 may be used as the method of recognizing the first denomination basis loading number and the second denomination basis loading number.

The control unit 43A determines the loading order of each coin of the first coin group C1 such that the fewer the number of the coins of the denomination, the earlier the timing they are output from the cassette 5 (step S2). For example, in the case where the first coin group C1 is composed of 50 50 cent coins, 450 1 euro coins and 1000 2 euro coins, the loading order is determined such that each coin is loaded into the storage area 51 in the order of the 50 cent coin, the 1 euro coin and the 2 euro coin as illustrated in FIG. 4. For example, the control unit 43A determines the loading order such that the fewer the number of the coins of the denomination, the closer the loaded position is to the outlet of the cassette 5.

As illustrated in FIG. 4, under the control of the control unit 43A, the storage unit 41 and the loading unit 42 load the first coin group C1 into the storage area 51 in the loading order determined at step S2 (step S3).

As illustrated in FIG. 4, under the control of the control unit 43A, the storage unit 41 and the loading unit 42 load the second coin group C2 into the storage area 51 (step S4). As with the first coin group C1, the loading order of the coins of the second coin group C2 may be an order in which the fewer the number of the coins of the denomination, the earlier the timing they are output from the cassette 5, or an order set by the user, or, an order set in advance.

### Effects of Embodiment 2

The Embodiment 2 achieves the following effects in addition to the same effects as the effects of Embodiment 1. The coin loading apparatus 4A loads the coins of the first coin group C1 into the storage area 51 such that the fewer the number of the coins of the denomination, the earlier the timing they are output from the cassette 5. Thus, the coins of the denomination with a small number can be speedily and reliably provided to replenish the coin processing apparatus 3.

### Embodiment 3

Next, Embodiment 3 of the present disclosure is described with reference to the drawings. Note that the coin replenishment process using the coin processing apparatus is identical to that of Embodiment 1, and therefore the description thereof is omitted.

### Configuration of Coin Processing System

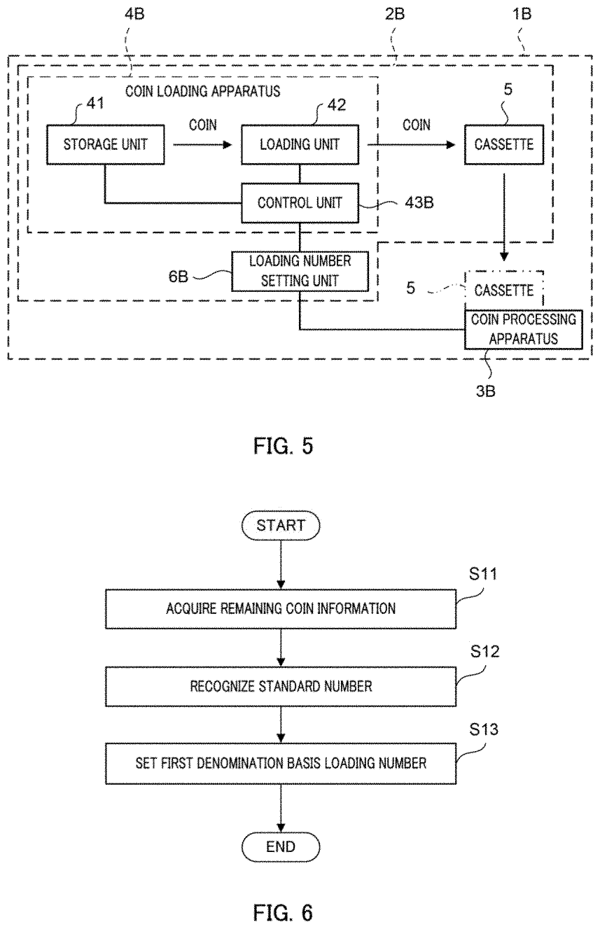

First, a configuration of the coin processing system is described. FIG. 5 is a block diagram illustrating an overall configuration of a coin processing system according to Embodiment 3 of the present disclosure.

A coin processing system 1B of Embodiment 3 illustrated in FIG. 5 includes a coin loading system 2B and a coin processing apparatus 3B. The coin loading system 2B includes a loading number setting unit 6B, a coin loading apparatus 4B, and the cassette 5. Note that while Embodiment 3 describes a configuration in which the loading number setting unit 6B is not included in the coin loading apparatus 4B, the loading number setting unit 6B may be included in the coin loading apparatus 4B.

The coin processing apparatus 3B is communicatively connected to the loading number setting unit 6B. The coin processing apparatus 3B transmits remaining coin information to the loading number setting unit 6B after a closing balance process. The closing balance process is a process performed after the store's business hours to count, for each denomination, the number, the total amount and the like of the coins that are stored in the cassette 5 during the store's business hours. The remaining coin information is used to specify the number of the coins (remaining coins) of each denomination remaining in the coin processing apparatus 3B after the closing balance process, before the initial replenishment in the coin processing apparatus 3B. In the case where the number of the remaining coins of each denomination is fixed at the same number each time, information that only notifies that the closing balance process has been performed may be used as the remaining coin information. In the case where the number of the remaining coins of each denomination can be changed for each closing balance process, information that specifies the number of the remaining coins of each denomination after the closing balance process may be used as the remaining coin information.

The loading number setting unit 6B is communicatively connected to the control unit 43B of the coin loading apparatus 4B. The loading number setting unit 6B sets the first denomination basis loading number on the basis of the remaining coin information transmitted from the coin processing apparatus 3B. The loading number setting unit 6B transmits, to the control unit 43B, information related to the set first denomination basis loading number. The process of the loading number setting unit 6B is elaborated later.

The control unit 43B recognizes the first denomination basis loading number on the basis of the information transmitted from the loading number setting unit 6B. The control unit 43B performs the control of loading the first coin group C1 into the cassette 5 on the basis of the first denomination basis loading number set by the loading number setting unit 6B as with the control unit 43 of Embodiment 1. The control unit 43B performs the control of loading of the second coin group C2 into the cassette 5 as with the control unit 43 of Embodiment 1.

### Coin Loading Process Using Coin Loading Apparatus

Next, a coin loading process using the coin loading apparatus 4B is described. Note that in the coin loading process, the processes other than the setting process of the first denomination basis loading number are same as those of Embodiment 1, and therefore the description thereof is omitted. FIG. 6 is a flowchart of a setting process of a first denomination basis loading number according to Embodiment 3 of the present disclosure.

As illustrated in FIG. 6, the loading number setting unit 6B acquires the remaining coin information transmitted from the coin processing apparatus 3B (step S11).

Next, the loading number setting unit 6B recognizes the standard number (step S12). The standard number is recorded in a memory unit, not illustrated in the drawing, of the loading number setting unit 6B, for example.

Next, the loading number setting unit 6B sets the first denomination basis loading number (step S13). The loading number setting unit 6B calculates the number obtained by subtracting the remaining number based on the remaining coin information from the standard number for each denomination, and sets the calculation result as the first denomination basis loading number.

### Effects of Embodiment 3

The Embodiment 3 achieves the following effects in addition to the same effects as the effects of Embodiment 1. The loading number setting unit 6B sets the first denomination basis loading number on the basis of the remaining coin information. The coin loading apparatus 4B loads the first coin group C1 into the cassette 5 on the basis of the details set by the loading number setting unit 6B. Thus, even when the user does not set the denomination basis loading number, the coin loading apparatus 4B can load the coins for initial replenishment into the cassette 5 such that the number of the coins remaining in the cassette 5 after the initial replenishment is minimum.

### Modifications of Embodiment 3

Under the control of the control unit 43B, the storage unit 41 and the loading unit 42 may load each coin of the first coin group C1 into the storage area 51 such that the fewer the number of the coins of the denomination, the earlier the timing they are output from the cassette 5, as in Embodiment 2.

### Embodiment 4

Next, Embodiment 4 of the present disclosure is described with reference to the drawings. Note that the coin replenishment process using the coin processing apparatus is identical to that of Embodiment 1, and therefore the description thereof is omitted.

### Configuration of Coin Processing System

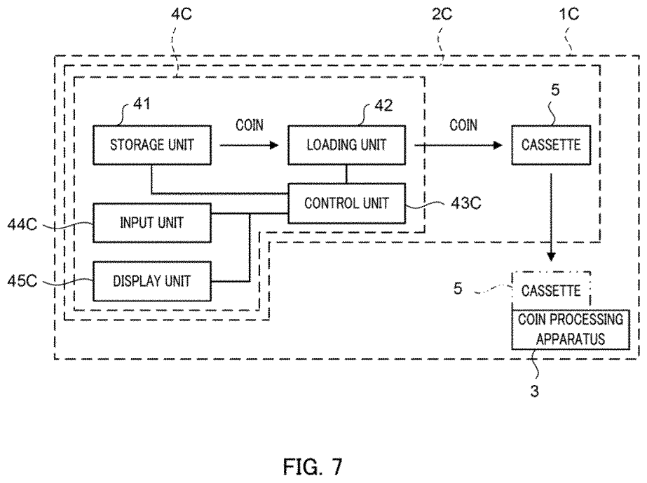

First, a configuration of the coin processing system is described. FIG. 7 is a block diagram illustrating an overall configuration of a coin processing system according to Embodiment 4 of the present disclosure.

A coin processing system 1C of Embodiment 4 illustrated in FIG. 7 includes a coin loading system 2C, and the coin processing apparatus 3. The coin loading system 2C includes a coin loading apparatus 4C, and the cassette 5. The coin loading apparatus 4C includes the storage unit 41, the loading unit 42, a control unit 43C, an input unit 44C, and a display unit 45C.

The input unit 44C transmits a signal based on the inputting operation by the user to the control unit 43C. The display unit 45C displays information based on the control of the control unit 43C. Note that at least one of the input unit 44C and the display unit 45C may be composed of a member separated from the coin loading apparatus 4C, or may be integrated with the coin loading apparatus 4C. As the input unit 44C and the display unit 45C, a touch-screen display apparatus may be used.

The control unit 43C receives a first inputting operation of the input unit 44C by the user. When the number of each denomination of the first coin group C1 for initial replenishment is input through the first inputting operation, the control unit 43C sets the first denomination basis loading number on the basis of the first inputting operation. As with the control unit 43 of Embodiment 1, the control unit 43C performs the control of loading the first coin group C1 into the cassette 5 on the basis of the set first denomination basis loading number. The control unit 43C receives a second inputting operation of the input unit 44C by the user. When the number of each denomination of the second coin group C2 for additional replenishment is input through the second inputting operation, the control unit 43C sets the second denomination basis loading number on the basis of the second inputting operation, and performs the control of loading of the second coin group C2 into the cassette 5 on the basis of the set second denomination basis loading number as with the control unit 43 of Embodiment 1.

### Coin Loading Process Using Coin Loading Apparatus

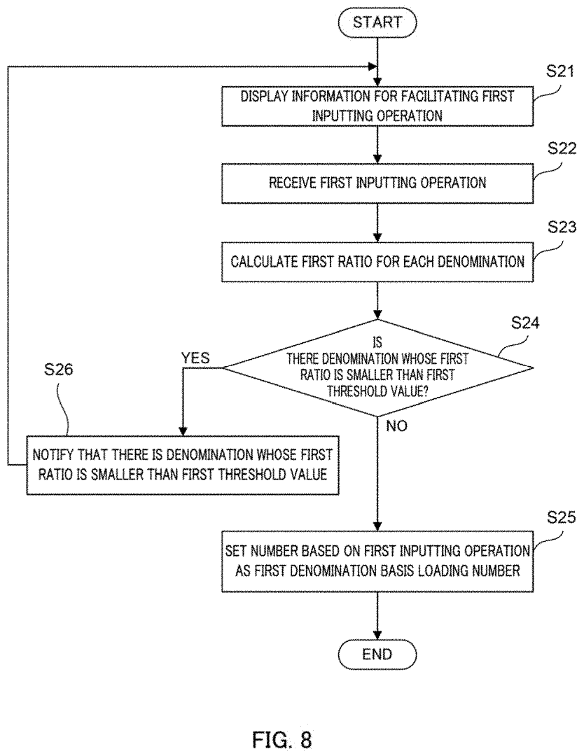

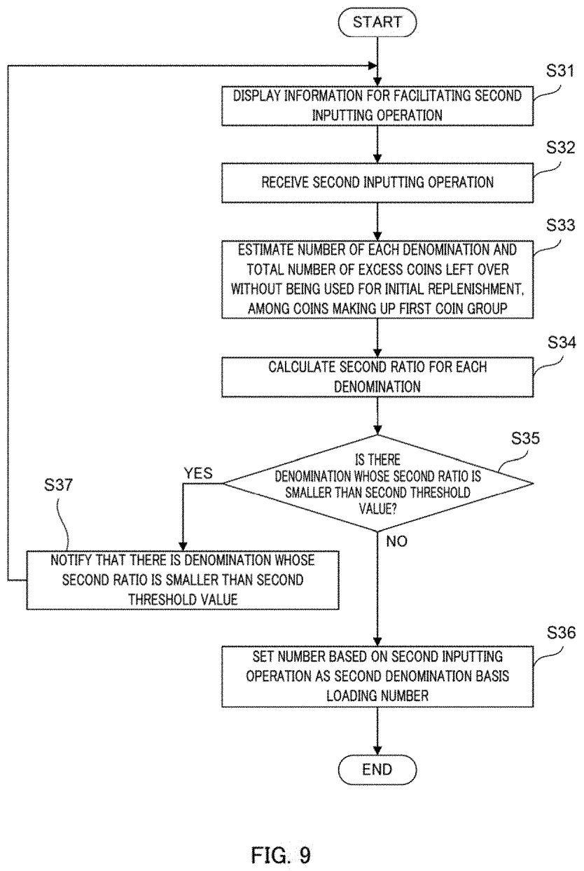

Next, a coin loading process using the coin loading apparatus 4C is described. Note that in the coin loading process, processes other than the process of setting the first denomination basis loading number and the second denomination basis loading number are identical to those of Embodiment 1, and therefore the description thereof is omitted. FIG. 8 is a flowchart of a setting process of a first denomination basis loading number according to Embodiment 4 of the present disclosure. FIG. 9 is a flowchart of a setting process of a second denomination basis loading number according to Embodiment 4 of the present disclosure.

First, the setting process of the first denomination basis loading number is described. As illustrated in FIG. 8, under the control of the control unit 43C, the display unit 45C displays information for facilitating the first inputting operation for setting the first denomination basis loading number (step S21).

When the user performs the first inputting operation using the input unit 44C, the control unit 43C receives the first inputting operation (step S22).

The control unit 43C calculates a first ratio for each denomination (step S23). The control unit 43C calculates, as the first ratio, the ratio of the number of the coins making up the first coin group C1 with respect to the total number of the coins making up the first coin group C1 set based on the first inputting operation. For example, in the case where the standard numbers of the 50 cent coin, 1 euro coin, and 2 euro coin making up the first coin group C1 are 50, 450 and 1000, respectively, when the first denomination basis loading numbers of the 50 cent coin, 1 euro coin, and 2 euro coin making up the first coin group C1 are set to the same numbers as the standard numbers (50, 450 and 1000) through the first inputting operation, the control unit 43C calculates 3.3% (50/(50+450+1000)) as the first ratio of the 50 cent coin. The control unit 43C calculates 30.0% and 66.7% as the first ratios of 1 euro coin and 2 euro coin, respectively.

The control unit 43C determines whether there is a denomination whose first ratio is smaller than a first threshold value in the coins of the denominations making up the first coin group C1 (step S24). The first threshold value is set based on the number of coins of each denomination desired by the user for initial replenishment, for example. The control unit 43C may set the first threshold value as a value input by the user using the input unit 44C, or may set the first threshold value based on a table of the relationship between the number of coins of each denomination for initial replenishment and the first threshold value, and the number of coins of each denomination desired for initial replenishment input by the user using the input unit 44C. For example, in the case where the user desires to set the total number of the coins making up the first coin group C1 to at most 1500 in anticipation of insufficiency of change, the first threshold value is set to 10% (for initial replenishment of three types of denominations, 150 or more coins are required for each denomination). In addition, for example, in the case where the user desires to set the total number of the coins making up the first coin group C1 to at most approximately 200 to 300 in anticipation of no insufficiency of change, the first threshold value is set to 5% (for initial replenishment of three types of denominations, approximately 3 to 5 coins for each denomination).

When it is determined that there is no denomination whose first ratio is smaller than the first threshold value (step S24: NO), the control unit 43C sets, as the first denomination basis loading number, the number of coins of each denomination based on the first inputting operation (step S25).

When it is determined that there is a denomination whose first ratio is smaller than the first threshold value (step S24: YES), the control unit 43C performs a control of notifying that there is the denomination whose first ratio is smaller than the first threshold value (step S26). For example, the control unit 43C controls the display unit 45C such that the display unit 45C displays the fact that there is the denomination whose first ratio is smaller than the first threshold value. Note that the display unit 45C may further display at least one of the total number of the coins making up the first coin group C1 on the basis of the first inputting operation, the first denomination basis loading number of all denominations, and the first threshold value and the first ratio of all denominations. When displaying the first denomination basis loading number of all denominations, the display unit 45C may display the first denomination basis loading number of the denomination whose first ratio is smaller than the first threshold value, with color and/or size different from that of the first denomination basis loading number of the denomination that is equal to or greater than the first threshold value. In addition, in the case where a sound output unit such as a speaker is disposed in the coin loading apparatus 4C, the sound output unit may output a sound and/or a voice that notifies that there is the denomination whose first ratio is smaller than the first threshold value under the control of the control unit 43C.

After the process of step S26, the display unit 45C performs the process of step S21 and displays information for facilitating the first inputting operation. Thereafter, until the user performs the first inputting operation so that there is no the denomination whose first ratio is smaller than the first threshold value, the control unit 43C and the display unit 45C repeat the processes of steps S21 to S24 and step S26.

Next, the process of setting the second denomination basis loading number is described. As illustrated in FIG. 9, after the setting of the first denomination basis loading number is completed, the display unit 45C under the control of the control unit 43C displays information for facilitating the second inputting operation for setting the second denomination basis loading number (step S31).

When the user performs the second inputting operation using the input unit 44C, the control unit 43C receives the second inputting operation (step S32).

On the basis of the standard number and the first denomination basis loading number set at step S25, the control unit 43C estimates the number of excess coins of each denomination and the total number of excess coins, which are coins that are left over without being used for the initial replenishment after the initial replenishment among the coins making up the first coin group C1 the coin processing apparatus 3 (step S33). When the setting process of the first denomination basis loading number illustrated in FIG. 8 is performed, the number of coins of each denomination is set such that the first ratio of all denominations making up the first coin group C1 is equal to or greater than the first threshold value regardless of the standard number, and consequently in some situation there is a denomination whose first denomination basis loading number is greater than the standard number. In this case, coins of the number obtained by subtracting the standard number from the first denomination basis loading number are left over as the excess coins without being used for the initial replenishment in the coin processing apparatus 3. The excess coins may include a coin that remains in the cassette 5 without ever being ejected from the cassette 5 to the coin processing apparatus 3. The excess coins may include a coin that has once ejected from the cassette 5 to the coin processing apparatus 3 but have been returned to the cassette 5 because the number of coins of the same denomination used for the initial replenishment of the coin processing apparatus 3 has reached the standard number. The control unit 43C estimates the total number of the excess coins and the number of the excess coins of each denomination.

The control unit 43C calculates a second ratio for each denomination (step S34). The control unit 43C calculates, as the second ratio, a ratio of the sum of the number of excess coins and the number of coins making up second coin group C2 with respect to the sum of the total number of the excess coins estimated at step S33 and the total number of the coins making up the second coin group C2 set based on the second inputting operation. For example, in the case where it is estimated that only 150 50 cent coins in the first coin group C1 are left over as the excess coins through the process of step S33, and the second denomination basis loading numbers of the 50 cent coin, 1 euro coin, and 2 euro coin making up the second coin group C2 are set to 50, 450 and 1000, respectively through the second inputting operation, the control unit 43C calculates 12.1% ((150+50)/(150+50+450+1000)) as the second ratio of the 50 cent coin.

The control unit 43C determines whether there is a denomination whose second ratio is smaller than the second threshold value in the denominations of the coins making up the second coin group C2 (step S35). The second threshold value is set based on the number of coins of each denomination desired by the user for additional replenishment, for example. The control unit 43C can set the second threshold value by the same method as the first threshold value setting method. The second threshold value may be or may not be the same as the first threshold value.

When it is determined that there is no denomination whose second ratio is smaller than the second threshold value (step S35: NO), the control unit 43C sets the number of coins of each denomination based on the second inputting operation as the second denomination basis loading number (step S36).

When it is determined that there is a denomination whose second ratio is smaller than the second threshold value (step S35: YES), the control unit 43C performs a control of notifying that there is a denomination whose second ratio is smaller than the second threshold value (step S37). A control similar to the control of notifying that there is the denomination whose first ratio is smaller than the first threshold value may be exemplified as the control of notifying that there is a denomination whose second ratio is smaller than the second threshold value.

After the process of step S37, the display unit 45C performs the process of step S31 and displays information for facilitating the second inputting operation. Thereafter, until the user performs the second inputting operation so that there is no denomination whose second ratio is smaller than the second threshold value, the control unit 43C and the display unit 45C repeat the processes of steps S31 to S35 and step S37.

### Effects of Embodiment 4

The Embodiment 4 achieves the following effects in addition to the same effects as the effects of Embodiment 1. The coin loading apparatus 4C sets the first denomination basis loading number on the basis of the first inputting operation by the user, and sets the second denomination basis loading number on the basis of the second inputting operation. Thus, the user can perform the initial replenishment and the additional replenishment in the coin processing apparatus 3 with coins of the number corresponding to the estimation on the change to be paid of the user.

In the case where there is the denomination whose first ratio is smaller than the first threshold value, the number of the coins of that denomination can possibly be extremely smaller than that of coins of other denominations. The coins of the denomination of extremely small number may not come out of the cassette 5 easily. As a result, there is a risk that the number required will not be easily available, and that the initial replenishment will take a long time. The same applies to the coins of the denomination whose second ratio is smaller than the second threshold value. In view of this, as in Embodiment 4, by making a notification that there is a denomination whose first ratio is smaller than the first threshold value or there is a denomination whose second ratio is smaller than the second threshold value, it is possible to inform the user of the risk of the occurrence of the above-mentioned defect so that the user can take appropriate measure against that defect.

### Modifications of Embodiment 4

Under the control of the control unit 43C, the storage unit 41 and the loading unit 42 may load each coin of the first coin group C1 into the storage area 51 such that the fewer the number of the coins of the denomination, the earlier the timing they are output from the cassette 5, as in Embodiment 2.

In the case where there is a denomination whose first and second ratios are smaller than the first and second threshold values, the control unit 43C need not perform a control of notifying that fact.

In the case where there is a denomination whose first and second ratios are smaller than the first and second threshold values, the control unit 43C may reset the first and second denomination basis loading numbers such that there is no denomination whose first and second ratios are smaller than the first and second threshold values, without again accepting the first and second inputting operations by the user. In this case, the display unit 45C may display a fact that the control unit 43C has reset the first and second denomination basis loading numbers under the control of the control unit 43C.

In the case where there is a denomination whose first and second ratios are smaller than the first and second threshold values, the control unit 43C may cause the display unit 45C to display a screen for the user to select whether the user again performs the first and second inputting operations, or the control unit 43C sets the first and second denomination basis loading numbers.

The control unit 43C need not set the first denomination basis loading number on the basis of the first ratio, and in this case, the process of step S25 may be performed after the process of step S22 is performed, or the first denomination basis loading number may be set on the basis of the remaining coin information as in Embodiment 3.

The control unit 43C need not set the second denomination basis loading number on the basis of the second ratio, and in this case, the process of step S36 may be performed after the process of step S32.

At step S34, the control unit 43C may calculate, as the second ratio, a ratio of the number of the coins making up the second coin group C2 with respect to the total number of the coins making up the second coin group C2 set based on the second inputting operation, as with the process of step S23. In this case, the process of step S33 becomes unnecessary.

The control unit 43C may set the first denomination basis loading number on the basis of information recorded in the memory unit not illustrated in the drawing without performing the setting process of the first denomination basis loading number illustrated in FIG. 8. The control unit 43C may set the second denomination basis loading number on the basis of information recorded in the memory unit not illustrated in the drawing without performing the second denomination basis loading number setting process illustrated in FIG. 9.

In the case where there is a coin remaining in the cassette 5 before the loading of coins, the control unit 43C may set the first and second denomination basis loading numbers for each denomination such that the first and second ratios are equal to or greater than the first and second threshold values, without including that remaining coins. In this case, the display unit 45C may display the first and second denomination basis loading numbers. In addition, the control unit 43C may control the storage unit 41 and the loading unit 42 such that after all coins remaining in the cassette 5 are stored in the storage unit 41 by denomination, the coins of the first and second denomination basis loading numbers are loaded into the cassette 5, and then, the coins of the denomination and the number corresponding to the coins remaining in the cassette 5 are returned to the cassette 5.

### Embodiment 5

Next, Embodiment 5 of the present disclosure is described with reference to the drawings.

### Configuration of Coin Processing System

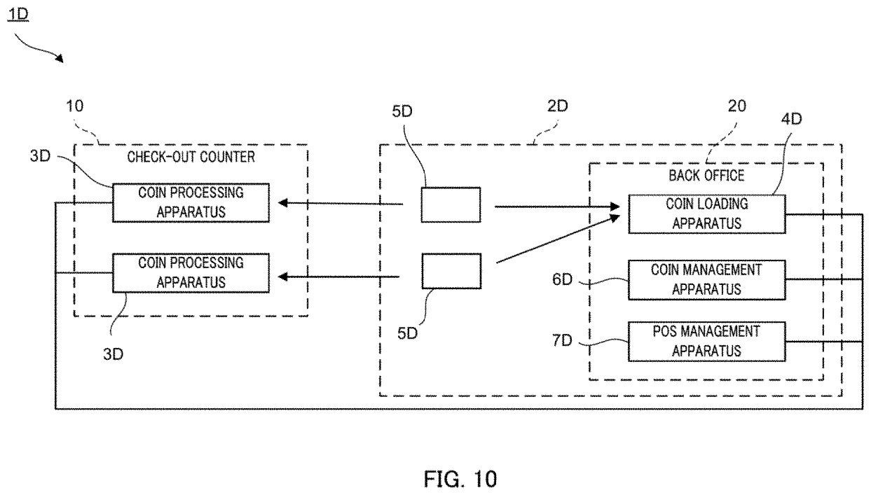

First, a configuration of the coin processing system is described. In Embodiment 5, a coin processing system used in a store is described. The front office of a store is an area where a coin determination apparatus for customers to make determination of goods is installed. The back office of a store is an area where an apparatus that manages banknotes and coins handled in the coin determination apparatus is installed. FIG. 10 is a block diagram illustrating an overall configuration of a coin processing system according to Embodiment 5 of the present disclosure.

A coin processing system 1D illustrated in FIG. 10 is a distribution system, and is installed in a store. The coin processing system 1D includes one coin loading system 2D, and two coin processing apparatuses 3D. The coin loading system 2D includes one coin loading apparatus 4D, two cassettes 5D, one coin management apparatus 6D, and one POS management apparatus 7D. Note that the coin processing system 1D may include one or three or more coin processing apparatuses 3D.

The coin processing apparatus 3D is installed at a check-out counter 10, which is an example of a front office of a store. The coin processing apparatus 3D is operated by a clerk or a customer himself, and is used for the determination process between the clerk and the customer. The coin processing apparatus 3D deposits the purchase price to be paid by the customer, or dispenses the change to be paid to the customer. The coin processing apparatus 3D is communicatively connected to a POS register not illustrated in the drawing to be operated by the clerk, or a self-checkout register not illustrated in the drawing to be operated by the customer. Note that the coin processing apparatus 3D may be configured integrally with the POS register or the self-checkout register.

The coin loading apparatus 4D, the coin management apparatus 6D and the POS management apparatus 7D are installed in a back office 20 of the store. The coin loading apparatus 4D is communicatively connected to each coin processing apparatus 3D. The coin loading apparatus 4D dispenses the change fund to be loaded into the coin processing apparatus 3D, or receives the proceeds from sales collected from the coin processing apparatus 3D. The coin loading apparatus 4D is elaborated later.

The coin management apparatus 6D is communicatively connected to each coin processing apparatus 3D and the coin loading apparatus 4D through a LAN (Local Area Network) and the like. The coin management apparatus 6D manages the coins stored in each coin processing apparatus 3D and the coin loading apparatus 4D. For example, the coin management apparatus 6D manages coins having been subjected to the determination in each coin processing apparatus 3D, and coins exchanged between the coin processing apparatus 3D and the coin loading apparatus 4D.

In addition, the coin management apparatus 6D manages the standard number of the two coin processing apparatuses 3D by using a memory unit not illustrated in the drawing. The standard number may be different for each coin processing apparatuses 3D, or may be the same between the two coin processing apparatuses 3D. The coin management apparatus 6D manages the remaining coin information transmitted from the coin processing apparatus 3D by using the memory unit. The coin management apparatus 6D has functions similar to those of the loading number setting unit 6B of Embodiment 3, and sets the first denomination basis loading number on the basis of the remaining coin information and the standard number. The coin management apparatus 6D transmits the set information related to the first denomination basis loading number, to the coin loading apparatus 4D. The POS management apparatus 7D manages the flow of goods.

The cassette 5D is configured to be detachable to the coin processing apparatus 3D and the coin loading apparatus 4D. The cassette 5D is configured to exchange the coin C with the coin processing apparatus 3D or the coin loading apparatus 4D when the cassette 5D is mounted to the coin processing apparatus 3D or the coin loading apparatus 4D. On the other hand, the cassette 5D is configured such that the coin C inside cannot be taken out when the cassette 5D is separated from the coin processing apparatus 3D or the coin loading apparatus 4D. The clerk transports the coin C between the coin processing apparatus 3D and the coin loading apparatus 4D by using the cassette 5D. For example, during the loading of the change fund or during collection of proceeds from sales, the clerk transports the coin C between the coin processing apparatus 3D and the coin loading apparatus 4D by using the cassette 5D. The clerk cannot touch the coin C in the cassette 5D when the coin C is being transported. Thus, the coin C can be transported in a safe state in terms of security. Note that it is possible to adopt a configuration in which only an authorized person such as the administrator of the store is allowed to open the cassette 5D.

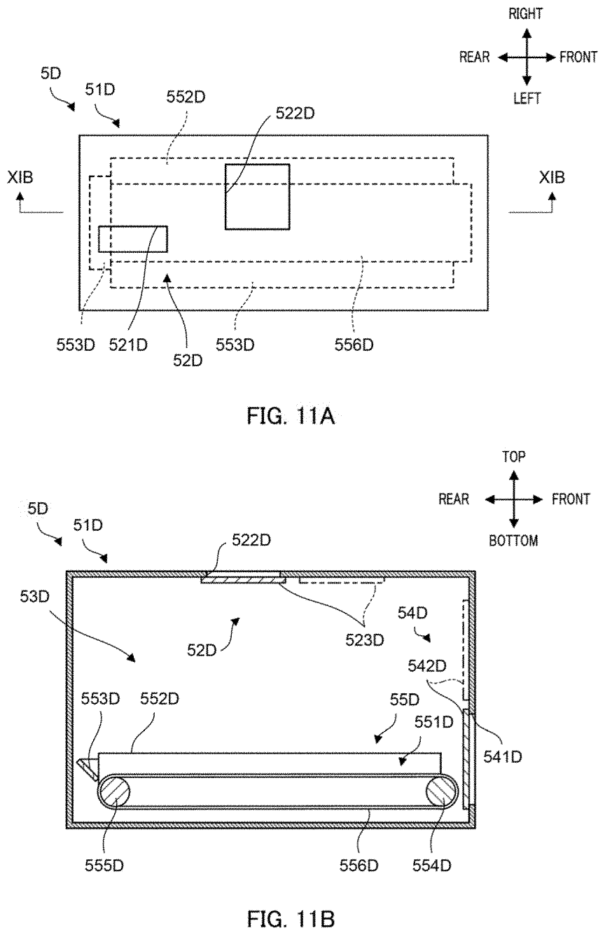

Next, a configuration of the cassette 5D is described. FIG. 11A is a top view illustrating an overall configuration of a cassette according to Embodiment 5 of the present disclosure. FIG. 11B is a sectional view taken along XIB-XIB of FIG. 11A. Note that the installation and the like of each component of the cassette 5D may be described using the direction illustrated in FIG. 11A and FIG. 11B.

As illustrated in FIG. 11A and FIG. 11B, the cassette 5D includes a housing 51D, a reception unit 52D, a storage area 53D, an ejection unit 54D, a feeding unit 55D, and a connector not illustrated in the drawing.

The reception unit 52D receives the coin C from the coin processing apparatus 3D or the coin loading apparatus 4D. The reception unit 52D includes a first inlet 521D, a second inlet 522D, an inlet closing member 523D, and an inlet opening closing mechanism not illustrated in the drawing. The first inlet 521D and the second inlet 522D are provided in the top surface part of the housing 51D. The first inlet 521D is configured to receive the coin C from the coin processing apparatus 3D. The second inlet 522D is configured to receive the coin C from the coin loading apparatus 4D. The inlet closing member 523D is formed in a shape that can simultaneously close the first inlet 521D and the second inlet 522D. The inlet opening closing mechanism opens and closes the first inlet 521D and the second inlet 522D at the same time by moving the inlet closing member 523D.

The storage area 53D is an inner space of the housing 51D. The storage area 53D stores the coin C received at the reception unit 52D.

The ejection unit 54D ejects the coin C stored in the storage area 53D. The ejection unit 54D includes an outlet 541D, an outlet closing member 542D, and an outlet opening closing mechanism not illustrated in the drawing.

The outlet 541D is provided on the lower side in the front surface part of the housing 51D. The outlet opening closing mechanism opens and closes the outlet 541D by moving the outlet closing member 542D.

The feeding unit 55D sends out and ejects the coin C stored in the storage area 53D from the ejection unit 54D. The feeding unit 55D includes a transport mechanism 551D, a pair of side wall parts 552D, and a rear wall part 553D.

The transport mechanism 551D includes a transport motor not illustrated in the drawing, a drive pulley 554D, a driven pulley 555D, and a transport belt 556D. The transport motor drives under the control of the coin processing apparatus 3D or the coin loading apparatus 4D. The drive pulley 554D is provided at the rotation shaft of the transport motor so as to extend in the left and right direction on the front and lower sides of the cassette 5D. The driven pulley 555D is received by a bearing not illustrated in the drawing so as to extend in the left and right direction on the rear and lower sides of the cassette 5D. The transport belt 556D is provided around the drive pulley 554D and the driven pulley 555D. The coin C received from the reception unit 52D is placed on the transport belt 556D. That is, the transport belt 556D makes up a placing part of the storage area 53D. The pair of side wall parts 552D is provided at both sides of the transport belt 556D in the width direction. The rear wall part 553D is provided on the rear side of the transport belt 556D.

The connector is provided in the left surface part in the housing 51D, for example. When the cassette 5D is mounted to the coin processing apparatus 3D, the connector is connected to the connector, not illustrated in the drawing, of the coin processing apparatus 3D. When mounted to the coin loading apparatus 4D, the connector is connected to the connector, not illustrated in the drawing, of the coin loading apparatus 4D. When the connector is connected to the connector of the coin processing apparatus 3D or the coin loading apparatus 4D, feeding is performed through the connector to the components that operate with the feeding, such as the inlet opening closing mechanism, the outlet opening closing mechanism and the transport motor. When the connector is connected to the connector of the coin processing apparatus 3D or the coin loading apparatus 4D, the coin processing apparatus 3D or the coin loading apparatus 4D can control the cassette 5D through the connector.

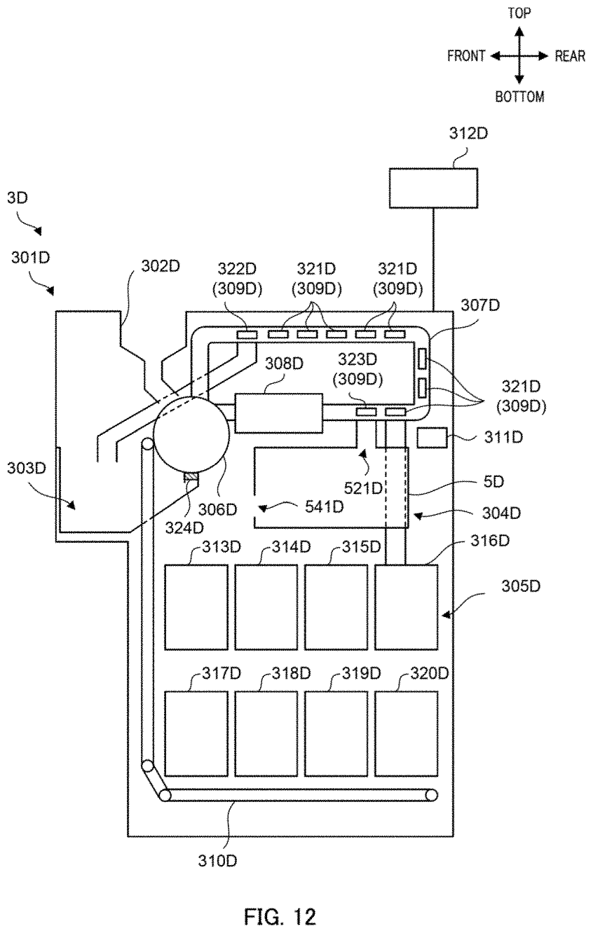

Next, a configuration of the coin processing apparatus 3D is described. FIG. 12 is a schematic view as viewed from the right side, illustrating an internal configuration of a coin processing apparatus according to Embodiment 5 of the present disclosure. Note that the installation and the like of each component of the coin processing apparatus 3D may be described using the direction illustrated in FIG. 12.

As illustrated in FIG. 12, the coin processing apparatus 3D includes a housing 301D, a deposit unit 302D, a dispense unit 303D, a first cassette mounting unit 304D, a storage unit 305D, a feeding unit 306D, a deposit transport unit 307D, a recognition unit 308D, a plurality of chutes 309D, a dispense transport unit 310D, and a control unit 311D.

The deposit unit 302D is provided on the front side in the top surface part in the housing 301D. That is, the deposit unit 302D is provided on the side on which the customer operating the coin processing apparatus 3D stands. The deposit unit 302D is configured to deposit the coin C to the coin processing apparatus 3D. The dispense unit 303D is provided on the upper side in front surface part in the housing 301D. The dispense unit 303D is configured to dispense the coin C from the coin processing apparatus 3D.

The first cassette mounting unit 304D is hidden with a cover when the cassette 5D is not mounted, and the first cassette mounting unit 304D is exposed when the cover not illustrated in the drawing is open. When the clerk mounts the cassette 5D to the first cassette mounting unit 304D, the connector of the cassette 5D and the connector, not illustrated in the drawing, of the first cassette mounting unit 304D are connected to each other.

An operation display unit 312D is connected to the coin processing apparatus 3D. The operation display unit 312D is composed of a touch-screen display apparatus, and functions as an operation unit for inputting information related to the coin processing in the coin processing apparatus 3D, and a display unit for displaying information related to the coin processing. Note that the operation display unit 312D may be composed of a member separated from the coin processing apparatus 3D, or may be integrated with the coin processing apparatus 3D. The operation display unit 312D may have a configuration in which the operation unit and the display unit are independently provided.

The storage unit 305D includes a plurality of (eight, in Embodiment 5) denomination basis storage units 313D, 314D, 315D, 316D, 317D, 318D, 319D and 320D (hereinafter referred to also as “denomination basis storage units 313D to 320D”). The denomination basis storage units 313D to 320D are configured to store the coin C and to send out the stored coin C. As a mechanism for sending out the coin C of the denomination basis storage units 313D to 320D, a mechanism that uses a centrifugal disk that rotates in a tilted state and picks up and sends out the coin C one by one using a plurality of protrusion members provided in the outer region in the surface of the centrifugal disk may be exemplified. The denominations to be stored in the denomination basis storage units 313D to 320D are set in advance.

The feeding unit 306D is configured to receive and send out one by one the coin C deposited from the deposit unit 302D, and to drop the coin to the dispense unit 303D. For the mechanism that sends out the coin C of the feeding unit 306D, the same mechanism as that of the denomination basis storage units 313D to 320D may be exemplified.

The deposit transport unit 307D transports the coin C sent out from the feeding unit 306D.

The recognition unit 308D, which is provided in the deposit transport unit 307D, recognizes the denomination, authentication, fitness and the like of the coin C deposited from the deposit unit 302D, and counts the coin C for each denomination.

The plurality of chutes 309D is provided downstream of the recognition unit 308D in the deposit transport unit 307D in the transport direction of the coin C. The plurality of chutes 309D is provided side by side in a line in the transport direction of the coin C. Eight chutes 321D in the plurality of chutes 309D are configured to guide the coin C to one of the denomination basis storage units 313D to 320D. One chute 322D is configured to guide the coin C to the dispense unit 303D. The remaining one chute 323D is configured to guide the coin C to the cassette 5D. Chute 309D is normally closed with a gate not illustrated in the drawing, and guides the coin C to the above-mentioned each unit when the gate is opened.

The dispense transport unit 310D is provided below the feeding unit 306D. The dispense transport unit 310D transports, to the feeding unit 306D, the coin C sent out from the denomination basis storage units 313D to 320D. The dispense transport unit 310D transport, to the feeding unit 306D, the coin C ejected and dropped from the cassette 5D.

The control unit 311D controls the entire operation of the coin processing apparatus 3D. The control unit 311D controls the deposit process of the coin C paid by the customer during the determination of goods. When controlling the deposit process, for example, the control unit 311D controls the feeding unit 306D and the deposit transport unit 307D so as to send out and transport one by one the coin C received from the deposit unit 302D and dropped to the feeding unit 306D. The denomination, authentication, fitness and the like of the transported coin are recognized by the recognition unit 308D. The control unit 311D controls the deposit transport unit 307D and the gate on the basis of the recognition result in the recognition unit 308D so as to eject, from the dispense unit 303D, the coin C that cannot be deposited, as a reject coin. The control unit 311D controls the deposit transport unit 307D and chute 309D so as to house, in the denomination basis storage units 313D to 320D by denomination, the coin C that can be deposited.

The control unit 311D controls the dispense process of the coin C during the determination of goods. When controlling the dispense process, the control unit 311D controls the denomination basis storage units 313D to 320D and the dispense transport unit 310D so as to transport one by one, to the feeding unit 306D, the coin C sent out and dropped from the denomination basis storage units 313D to 320D storing the coins C to be dispensed, for example. The control unit 311D controls the feeding unit 306D to eject the coin C to the dispense unit 303D by opening a bottom portion 324D of the feeding unit 306D.

The control unit 311D performs a control for initial replenishment in the storage unit 305D with coin C stored in the cassette 5D before the opening of the store, for example. The control unit 311D performs a control of additional replenishment in the storage unit 305D with the coin C to be subjected to the additional replenishment among the coins C stored in the cassette 5D during the store operation. The control unit 311D performs a control of collecting the coin C stored in the storage unit 305D to the cassette 5D after the store has been closed, for example.

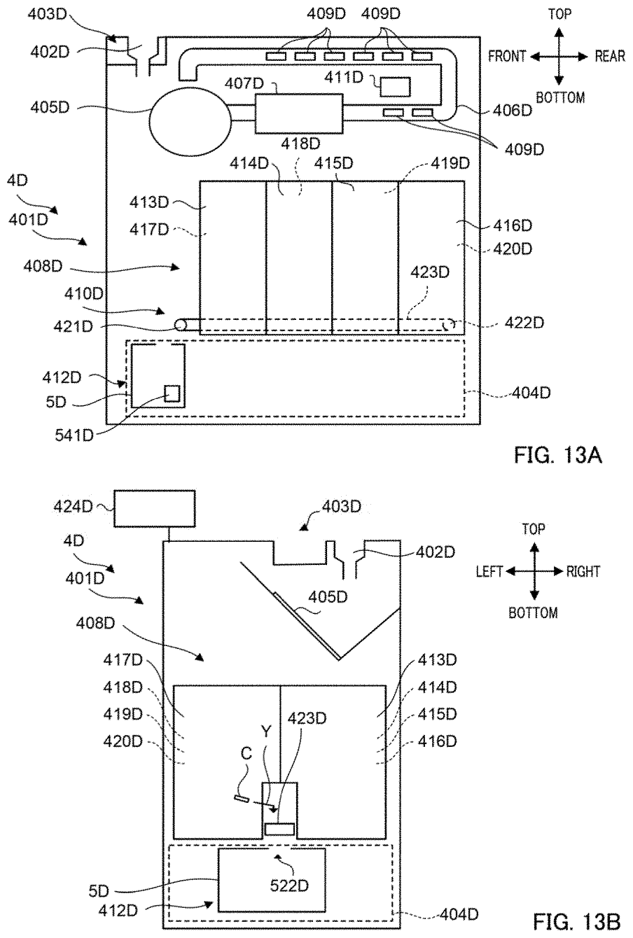

Next, a configuration of the coin loading apparatus 4D is described. FIG. 13A is a schematic view as viewed from the right side, illustrating an internal configuration of a coin loading apparatus when a coin is loaded into a cassette according to Embodiment 5 of the present disclosure. FIG. 13B is a schematic view as viewed from the front side, illustrating an internal configuration of the coin loading apparatus when a coin is loaded into the cassette according to Embodiment 5 of the present disclosure. Note that the installation and the like of each component of the coin loading apparatus 4D may be described using the direction illustrated in FIG. 13A and FIG. 13B.

As illustrated in FIG. 13A and FIG. 13B, the coin loading apparatus 4D includes a housing 401D, a deposit unit 402D, a second cassette mounting unit 403D, a dispense unit 404D, a feeding unit 405D, a transport unit 406D, a recognition unit 407D, a storage unit 408D, a plurality of upper chutes 409D, a loading unit 410D, and a control unit 411D. Further, the coin loading apparatus 4D includes a reject unit, an overflow storage unit and a counterfeit coin storage unit not illustrated in the drawing.

The deposit unit 402D is provided on the front side in the top surface part of the housing 401D. That is, the deposit unit 402D is provided on the side on which the clerk operating the coin loading apparatus 4D stands. The deposit unit 402D is configured to deposit the coin C to the coin loading apparatus 4D.

The second cassette mounting unit 403D is provided on the front side in the top surface part of the housing 401D. The second cassette mounting unit 403D is provided next to the deposit unit 402D. When the clerk mounts the cassette 5D to the second cassette mounting unit 403D, the connector of the cassette 5D and the connector, not illustrated in the drawing, of the second cassette mounting unit 403D are connected to each other. In addition, the housing 401D is provided with an opening, not illustrated in the drawing, which faces the outlet 541D of the cassette 5D mounted to the second cassette mounting unit 403D. The coin C ejected from the outlet 541D of the cassette 5D can be deposited to the coin loading apparatus 4D through the opening.

The dispense unit 404D is provided at a lower side portion inside the housing 401D. The dispense unit 404D includes a drawer unit that can be drawn to the front side of the housing 401D. The clerk can put in the cassette 5D to the drawer unit drawn to the front side, and can put out the cassette 5D from the drawer unit. The dispense unit 404D includes a third cassette mounting unit 412D to which the cassette 5D is mounted.

The cassette 5D is mounted to the third cassette mounting unit 412D. When the clerk mounts the cassette 5D to the third cassette mounting unit 412D, the connector of the cassette 5D and the connector, not illustrated in the drawing, of the third cassette mounting unit 412D are connected to each other.

The feeding unit 405D is configured to receive the coin C deposited from the deposit unit 402D and/or the cassette 5D, so as to send out the coin one by one and/or to drop the coin to the dispense unit 404D. A component similar to that of the denomination basis storage units 313D to 320D of the coin processing apparatus 3D may be exemplified as a mechanism for sending out the coin C of the feeding unit 405D.

The transport unit 406D transports the coin C sent out from the feeding unit 405D.

The recognition unit 407D, which is provided in the transport unit 406D, recognizes and counts the denomination, authentication, fitness and the like of the coin C deposited from the deposit unit 402D.

The storage unit 408D includes a plurality of (eight, in Embodiment 5) denomination basis storage units 413D, 414D, 415D, 416D, 417D, 418D, 419D, and 420D (hereinafter referred to also as “denomination basis storage units 413D to 420D”). The denomination basis storage units 413D to 420D are configured to store the coin C, and to send out the stored coin C. The denomination basis storage units 413D to 416D are provided side by side in the front-rear direction on the right side inside the housing 401D. The denomination basis storage units 417D to 420D are provided side by side in the front-rear direction on the left side inside the housing 401D. The denominations to be stored in the denomination basis storage units 413D to 420D are set in advance. A mechanism similar to that of the denomination basis storage units 313D to 320D may be exemplified as a mechanism for sending out the coins C of the denomination basis storage units 413D to 420D.

The reject unit stores, as a reject coin, the coin C recognized to be a non-processing target and/or a non-recognizable coin in the recognition unit 407D. When the retaining amount of the coins C in the denomination basis storage units 413D to 420D exceeds a preset retaining amount, the overflow storage unit stores the coin C that cannot be no longer retained, as an overflow coin. The counterfeit coin storage unit stores the coin C that is recognized to be a counterfeit coin in the recognition unit 407D.

The upper chutes 409D are provided downstream of the recognition unit 407D in the transport unit 406D in the transport direction of the coin C. The upper chutes 409D are provided side by side in a line in the transport direction of the coin C. The eight upper chutes 409D are configured to guide the coin C to one of the denomination basis storage units 413D to 420D. In addition, although not shown in the drawings, the transport unit 406D is provided with an upper chute not illustrated in the drawing configured to guide the coin C to the reject unit, the overflow storage unit and the counterfeit coin storage unit. The upper chute 409D, which is normally closed with a gate not illustrated in the drawing, guides the coin C to the above-mentioned each unit when the gate is opened.

The loading unit 410D includes a transport motor not illustrated in the drawing, a drive pulley 421D, a driven pulley 422D, and a transport belt 423D. The transport motor is driven by a control of the control unit 411D. The drive pulley 421D is provided at the rotation shaft of the transport motor on the front and lower sides of the housing 401D so as to extend in the left and right direction. The driven pulley 422D is received at a bearing not illustrated in the drawing on the rear and lower sides of the housing 401D as to extend in the left and right direction. The transport belt 423D are provided around the drive pulley 421D and the driven pulley 422D. The transport belt 423D is configured to guide the coin C stored in the denomination basis storage units 413D to 420D, to the second inlet 522D of the cassette 5D mounted to the third cassette mounting unit 412D.

The control unit 411D controls the entire operation of the coin loading apparatus 4D. The control unit 411D counts the coins C collected from the coin processing apparatus 3D by the cassette 5D. The control unit 411D performs a control of replenishing the cassette 5D with the coin C stored in the storage unit 408D.

In addition, an operation display unit 424D is connected to the coin loading apparatus 4D. A configuration similar to the operation display unit 312D connected to the coin processing apparatus 3D may be exemplified as the operation display unit 424D. The coin loading apparatus 4D functions as an input unit for inputting information related to the coin processing in the coin loading apparatus 4D, and a display unit that displays information related to the coin processing.

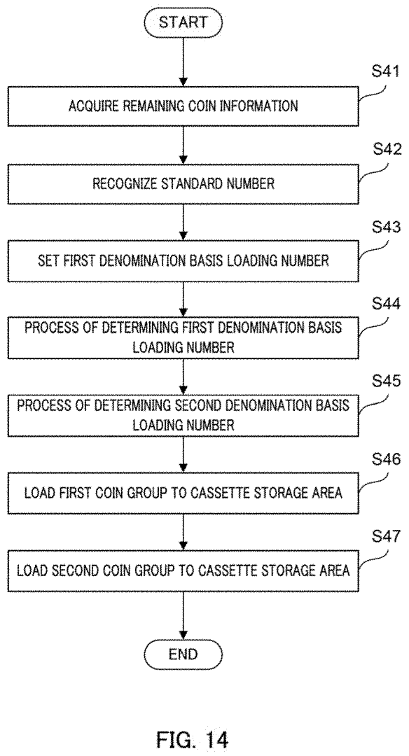

Coin Loading Process Using Coin Loading Apparatus Next, a coin loading process using the coin loading apparatus 4D is described as an operation of the coin processing system 1D. FIG. 14 is a flowchart of a coin loading process according to Embodiment 5 of the present disclosure.

When the closing balance process of each coin processing apparatus 3D is completed after the operation time of the store, the coin management apparatus 6D acquires and manages the remaining coin information of each coin processing apparatus 3D, for example.

Before the opening of the store, for example, the clerk mounts the empty cassette 5D with the first inlet 521D, the second inlet 522D and the outlet 541D closed, to the third cassette mounting unit 412D as illustrated in FIG. 13A and FIG. 13B so as to load the cassette 5D with the coins C for initial replenishment and additional replenishment by using the coin loading apparatus 4D. When the cassette 5D is mounted to the third cassette mounting unit 412D, the coin loading apparatus 4D starts the power feeding to the cassette 5D through the connector of the third cassette mounting unit 412D. The control unit 411D of the coin loading apparatus 4D controls the cassette 5D to open the first inlet 521D and the second inlet 522D of the cassette 5D.

When the clerk performs an inputting operation for starting the loading process of the coin C on the operation display unit 424D of the coin loading apparatus 4D in order to replenish a predetermined coin processing apparatus 3D (hereinafter referred to also as “the coin processing apparatus 3D to be replenished”) with the coin C, the control unit 411D of the coin loading apparatus 4D performs a control of transmitting the coin management apparatus 6D to information that specifies the coin processing apparatus 3D to be replenished.

The coin management apparatus 6D acquires the remaining coin information on the coin processing apparatus 3D to be replenished on the basis of the information from the coin loading apparatus 4D as illustrated in FIG. 14 (step S41).

Next, the coin management apparatus 6D recognizes the standard number of the coin processing apparatus 3D to be replenished (step S42).

Next, on the basis of the remaining coin information and standard number, the coin management apparatus 6D sets the first denomination basis loading number of the coin processing apparatus 3D to be replenished (step S43). At this time, the coin management apparatus 6D calculates the number obtained by subtracting the remaining number based on the remaining coin information from the standard number for each denomination, and sets the calculation result as the first denomination basis loading number. Note that a result of adding a certain margin value to the result of the subtraction may be set as the first denomination basis loading number. Thereafter, the coin management apparatus 6D transmits information related to the first denomination basis loading number, to the coin loading apparatus 4D.

When the information related to the first denomination basis loading number is acquired from the coin management apparatus 6D, the control unit 411D of the coin loading apparatus 4D performs a determination process of the first denomination basis loading number (step S44). For example, under the control of the control unit 411D, the operation display unit 424D displays the first denomination basis loading number set at the coin management apparatus 6D. When approving the first denomination basis loading number set by the coin management apparatus 6D, the clerk performs an inputting operation for approval on the operation display unit 424D. When the inputting operation for approval has been performed, the control unit 411D determines the first denomination basis loading number as the details set at the coin management apparatus 6D. On the other hand, when not approving the first denomination basis loading number set at the coin management apparatus 6D, the clerk performs the first inputting operation of the first denomination basis loading number desired to be set by the clerk on the operation display unit 424D. When the first inputting operation of the first denomination basis loading number is performed by the clerk, the control unit 411D determines the input details as the first denomination basis loading number. Note that when the first denomination basis loading number is determined as the details set at the coin management apparatus 6D, the coins making up the first coin group C1 will not be left over as the excess coin after the initial replenishment (but will be left over in the case where addition of a margin value has been performed). On the other hand, when the first denomination basis loading number is determined as the details input by the clerk, the coins C making up the first coin group C1 can possibly be left over as the excess coin after the initial replenishment.

Next, the control unit 411D performs a determination process of the second denomination basis loading number (step S45). For example, under the control of the control unit 411D, the operation display unit 424D performs an indication for facilitating the second inputting operation of the second denomination basis loading number. When the clerk has performed the second inputting operation on the operation display unit 424D, the control unit 411D determines the second denomination basis loading number as the input details.

Next, the control unit 411D performs a control of loading the first coin group C1 for initial replenishment into the storage area 53D of the cassette 5D (step S46). First, the control unit 411D specifies a denomination basis storage unit storing the coin C of the denomination to be loaded first among the coins C making up the first coin group C1 in the denomination basis storage units 417D to 420D, and controls the denomination basis storage unit to guide the coin C sent out from the specified denomination basis storage unit to the transport belt 423D of the loading unit 410D as indicated with the arrow Y in FIG. 13B. Under the control of the control unit 411D, the loading unit 410D drives the transport motor, and loads the coin C guided to the transport belt 423D, into the storage area 53D through the second inlet 522D. The control unit 411D controls the denomination basis storage units 417D to 420D and the loading unit 410D such that the coin C of each denomination making up the first coin group C1 is loaded into the storage area 53D. At this time, the loading unit 410D may load the coin C while driving the transport belt 556D so that the coin C is not unevenly placed on the transport belt 556D.

Next, when the loading of the first coin group C1 into the storage area 53D is completed, the control unit 411D performs a control of loading of the second coin group C2 for additional replenishment into the storage area 53D of the cassette 5D (step S47). The control unit 411D loads the coin C of each denomination making up the second coin group C2 into the storage area 53D by performing the same control as that of step S46. At this time, the loading unit 410D may load the coin C while driving the transport belt 556D so that the coin C is not unevenly placed on the transport belt 556D.

Through the processes of steps S41 to S47, the second coin group C2 is loaded on the first coin group C1, as illustrated in FIG. 2, for example. That is, the first coin group C1 and the second coin group C2 are loaded such that the second coin group C2 is located at a position farther from the outlet 541D than the first coin group C1, and that the first coin group C1 is easily output from the cassette 5D at an earlier timing than the second coin group C2.

When the loading process of the coin C into the cassette 5D is completed, the control unit 411D controls the cassette 5D to close the second inlet 522D of the cassette 5D. Under the control of the control unit 411D, the cassette 5D closes the first inlet 521D and the second inlet 522D at the same time. Thereafter, the clerk removes the cassette 5D from the coin loading apparatus 4D.

### Initial Replenishment Process of Coin at Coin Processing Apparatus

Next, an initial replenishment process of coin at the coin processing apparatus 3D is described as an operation of the coin processing system 1D.

Before the opening of the store, for example, the clerk mounts the cassette 5D replenished with the coin C to the first cassette mounting unit 304D of the coin processing apparatus 3D as illustrated in FIG. 12. When the cassette 5D is mounted to the first cassette mounting unit 304D, the coin processing apparatus 3D starts power feeding to the cassette 5D through the connector of the first cassette mounting unit 304D. The control unit 311D of the coin processing apparatus 3D controls the cassette 5D to eject the coin C stored in the storage area 53D.

Under the control of the control unit 311D, the cassette 5D opens the outlet 541D and sequentially sends out the coin C stored in the storage area 53D, from the outlet 541D. At this time, the coins C making up the first coin group C1 is ejected from the cassette 5D.

The coin C sent out from the cassette 5D drops to the dispense transport unit 310D. The control unit 311D controls the dispense transport unit 310D to transport the coin C sent out from the cassette 5D, to the feeding unit 306D. The control unit 311D controls the feeding unit 306D and the deposit transport unit 307D such that the coin C is sent out one by one from the feeding unit 306D, and the coin C sent out is transported toward the recognition unit 308D. The recognition unit 308D recognizes the denomination of the coin C being transported.

On the basis of the recognition result in the recognition unit 308D, the control unit 311D specifies the denomination basis storage units 313D to 320D corresponding to the coin C whose denomination has been recognized, and determines whether the storage number in the specified denomination basis storage unit has reached the standard number. When it is determined that it has not reached the standard number, the control unit 311D controls the denomination basis storage unit and the gate of the chute 321D to store the coin C whose denomination has been recognized to the denomination basis storage unit corresponding to the coin C. On the other hand, when it has reached the standard number, the control unit 311D controls the gate of the chute 323D to return the coin C whose denomination has been recognized into the storage area 53D through the first inlet 521D. The control unit 311D repeats the above-described control until the storage numbers of the coins C of all denominations for the initial replenishment in the denomination basis storage units 313D to 320D reach the standard number. When the storage number of the coins C of all denominations for initial replenishment has reached the standard number, the control unit 311D terminates the initial replenishment process of the coin C and controls the cassette 5D to close the outlet 541D.

### Additional Replenishment Process of Coin at Coin Processing Apparatus

Next, an additional replenishment process of the coin at the coin processing apparatus 3D is described as an operation of the coin processing system 1D. Note that descriptions for the same processes as those of the above-described initial replenishment process will be simplified.

For example, after performing the dispense process of the coin C (disbursement of change), the control unit 311D determines whether there is a denomination basis storage unit whose storage number of the coin C is lower than the lower limit value in the denomination basis storage units 313D to 320D. The lower limit value may differ for each denomination, or may be identical for all denominations.

When it is determined that there is a denomination basis storage unit whose storage number of the coin C is lower than the lower limit value, the control unit 311D performs the additional replenishment process of the coin C. The control unit 311D controls the cassette 5D to eject the coin C stored in the storage area 53D.

Under the control of the control unit 311D, the cassette 5D opens the outlet 541D and sequentially sends out the coin C stored in the storage area 53D, from the outlet 541D. At this time, the coin C making up the first coin group C1 has been ejected from the cassette 5D through the initial replenishment, and therefore the coin C making up the second coin group C2 is ejected from the cassette 5D.

The denomination of the coin C sent out from the cassette 5D is recognized by the recognition unit 308D. On the basis of the recognition result in the recognition unit 308D, the control unit 311D determines whether the coin C whose denomination has been recognized is the coin C of the denomination to be subjected to the additional replenishment. When it is determined that it is the coin C of the denomination to be subjected to the additional replenishment, the control unit 311D controls the denomination basis storage unit and the gate of the chute 321D to store the coin C in the denomination basis storage unit. On the other hand, when it is determined that it is not the coin C of the denomination to be subjected to the additional replenishment, the control unit 311D controls the gate of the chute 323D to return the coin C into the storage area 53D. The control unit 311D repeats the above-described control until the storage number of the coin C in the denomination basis storage unit corresponding to the denomination to be subjected to the additional replenishment becomes equal to or greater than the upper limit. The upper limit may differ for each denomination, or may be identical for all denominations. When the storage number of the coin C of the denomination basis storage unit corresponding to the denomination to be subjected to the additional replenishment becomes equal to or greater than the upper limit, the control unit 311D terminates the control of the additional replenishment process of the coin C, and controls the cassette 5D to close the outlet 541D.

### Effects of Embodiment 5

The Embodiment 5 achieves the following effects in addition to the same effects as the effects of Embodiment 1. When it is determined that the storage number in the denomination basis storage unit corresponding to the recognized coin C has reached the standard number in the initial replenishment, the coin processing apparatus 3D returns the recognized coin C into the storage area 53D. In this manner, the coin C returned into the storage area 53D can be used as the coin C for additional replenishment.

### Modifications of Embodiment 5

The loading unit 410D and the denomination basis storage units 413D to 420D may load each coin C of the first coin group C1 into the storage area 53D such that the fewer the number of the coins of the denomination, the earlier they are output from the cassette 5D under the control of the control unit 411D as in Embodiment 2. The control unit 411D may set the second denomination basis loading number based on the second ratio, or may set the first denomination basis loading number based on the first ratio as in Embodiment 4. When there is a denomination whose first and second ratios are smaller than the first and second threshold values, the operation display unit 424D may display that fact under the control of the control unit 411D.

### Modifications of Embodiments

It goes without saying that the present disclosure is not limited to the embodiments described so far, and various variations may be added to the extent that the purpose of the disclosure is not deviated from. For example, the storage unit 41, the loading unit 42 and the cassette 5 of the coin loading apparatuses 4, 4A, 4B and 4C of Embodiments 1 to 4 may be configured in the same manner as the storage unit 408D, the loading unit 410D, and the cassette 5D of the coin loading apparatus 4D described in Embodiment 5.

In Embodiments 1 to 5, coins for additional replenishment of multiple times may be loaded into the cassettes 5 and 5D. For example, it is possible to load coins such that after a 50 cent coin and a 1 euro coin are loaded as coins for the first additional replenishment, a 50 cent coin and a 2 euro coin are loaded as coins for the second additional replenishment.

In Embodiments 1 to 5, the control units 43, 43A, 43B, 43C and 411D control the loading process such that the first coin group C1 and the second coin group C2 are disposed side by side in the vertical direction, but the loading process may be controlled such that the first coin group C1 and the second coin group C2 are disposed side by side in the horizontal direction and that the first coin group C1 is easily output from the cassettes 5 and 5D at an earlier timing than the second coin group C2.

This application is entitled to and claims the benefit of Japanese Patent Application No. 2021-005157 filed on Jan. 15, 2021, the disclosure each of which including the specification, drawings and abstract is incorporated herein by reference in its entirety.

The present disclosure is applicable to coin loading methods, coin replenishment methods, coin loading apparatuses and coin processing systems.

1. A coin loading method of loading coins for replenishment of a coin processing apparatus, into a storage area provided in a cassette that is mountable to the coin processing apparatus, the coin loading method being performed before the cassette is mounted to the coin processing apparatus, the coin loading method comprising:
loading, into the storage area, a first coin group including a first plurality of coins for initial replenishment of the coin processing apparatus; and
loading, into the storage area, a second coin group including a second plurality of coins for additional replenishment of the coin processing apparatus, wherein
at least one of the first plurality of coins and the second plurality of coins includes the plural coins of each denomination of a plurality of denominations.

2. The coin loading method according to claim 1, wherein the loading of the first coin group is executed at an earlier timing than the loading of the second coin group, or the loading of the second coin group is executed at an earlier timing than the loading of the first coin group.

3. The coin loading method according to claim 1,
wherein the cassette includes an inlet configured to receive a coin from outside of the cassette and store the coin in the storage area, and an outlet provided at a position lower than the inlet in a state where the cassette is mounted to the coin processing apparatus, the outlet being configured to eject the coin loaded into the storage area to the coin processing apparatus; and
wherein the loading of the first coin group is executed at an earlier timing than the loading of the second coin group.

4. The coin loading method according to claim 1,
wherein the cassette includes an outlet configured to eject the coin loaded into the storage area to the coin processing apparatus; and
wherein in the loading of the second coin group, the second coin group is loaded into a location farther from the outlet than the first coin group.

5. The coin loading method according to claim 4, wherein the loading of the first coin group includes loading the first coin group into the storage area such that, among coins included in the first coin group, the fewer a number of coins of a denomination, the closer the coins are to the outlet.

6. The coin loading method according to claim 1, further comprising setting a number of coins making up the first coin group for each denomination in accordance with a number of coins of each denomination that are present in the coin processing apparatus before initial replenishment.

7. The coin loading method according to claim 1, further comprising:
receiving an inputting operation of specifying a number of coins for each denomination by a user; and
setting a number of coins of each denomination making up at least one of the first coin group and the second coin group in accordance with the inputting operation.

8. The coin loading method according to claim 7, further comprising at least one of
calculating a first ratio for each denomination, and notifying that there is a denomination whose first ratio is smaller than a first threshold value when there is the denomination whose first ratio is smaller than the first threshold value, the first ratio being a ratio of a number of coins making up the first coin group with respect to a total number of coins making up the first coin group set based on the inputting operation; or
calculating a second ratio for each denomination, and notifying that there is a denomination whose second ratio is smaller than a second threshold value when there is the denomination whose second ratio is smaller than the second threshold value, the second ratio being a ratio of a number of coins making up the second coin group with respect to a total number of coins making up the second coin group set based on the inputting operation.

9. The coin loading method according to claim 8, further comprising at least one of
again receiving the inputting operation related to a number of coins of each denomination making up the first coin group when there is the denomination whose first ratio is smaller than the first threshold value; or
again receiving the inputting operation related to a number of coins of each denomination making up the second coin group when there is the denomination whose second ratio is smaller than the second threshold value.

10. The coin loading method according to claim 7, further comprising at least one of
calculating a first ratio for each denomination, and setting a number of coins of each denomination making up the first coin group such that there is no denomination whose first ratio is smaller than a first threshold value when there is the denomination whose first ratio is smaller than the first threshold value, the first ratio being a ratio of a number of coins making up the first coin group with respect to a total number of coins making up the first coin group set based on the inputting operation; or
calculating a second ratio for each denomination, and setting a number of coins of each denomination making up the second coin group such that there is no denomination whose second ratio is smaller than a second threshold value when there is the denomination whose second ratio is smaller than the second threshold value, the second ratio being a ratio of a number of coins making up the second coin group with respect to a total number of coins making up the second coin group set based on the inputting operation.

11. A coin replenishment method of replenishing a coin processing apparatus with coins, the coin replenishment method comprising:
mounting a cassette to the coin processing apparatus, the cassette being loaded with coins of a plurality of denominations by the coin loading method according to claim 1;
receiving a coin from the cassette;
recognizing a denomination of a received coin;
determining whether it is necessary to replenish the coin processing apparatus with a recognized coin;
replenishing the coin processing apparatus with the recognized coin when it is determined that it is necessary to perform replenishment; and
returning the recognized coin to the cassette when it is determined that it is not necessary to perform replenishment.

12. The coin replenishment method according to claim 11, further comprising stopping the receiving of the coin from the cassette when a required coin replenishment is completed.

13. A coin loading apparatus configured to load coins for replenishment of a coin processing apparatus, into a storage area provided in a cassette that is mountable to the coin processing apparatus, the coin loading apparatus comprising:
a storage unit configured to store coins by denomination;
a loading unit configured to load coins stored in the storage unit into the storage area; and
a control unit configured to control the storage unit and the loading unit to load a first coin group including a first plurality of coins for initial replenishment of the coin processing apparatus and a second coin group including a second plurality of coins for additional replenishment of the coin processing apparatus, into the storage area at different timings before the cassette is mounted to the coin processing apparatus, wherein
at least one of the first plurality of coins and the second plurality of coins includes the plural coins of each denomination of a plurality of denominations.

14. A coin processing system comprising:
a coin processing apparatus;
a cassette that is mountable to the coin processing apparatus, the cassette including a storage area; and
a coin loading apparatus configured to load a coin for replenishment in the coin processing apparatus into the storage area,
wherein the coin loading apparatus includes:
a storage unit configured to store coins by denomination;
a loading unit configured to load coins stored in the storage unit into the storage area; and
a control unit configured to control the storage unit and the loading unit to load a first coin group including a first plurality of coins for initial replenishment of the coin processing apparatus and a second coin group including a second plurality of coins for additional replenishment of the coin processing apparatus, into the storage area at different timings before the cassette is mounted to the coin processing apparatus, wherein
at least one of the first plurality of coins and the second plurality of coins includes the plural coins of each denomination of a plurality of denominations.
